(19) United States
(12) Patent Application Publication
(10) Pub. No.: US 2026/0338977 A1
(43) Pub. Date: Oct. 29, 2026

(54) METHOD AND SYSTEM OF DETERMINING WELLBORE PROPERTY

(71) Applicant: Well-Sense Technology Limited, Dyce, Aberdeen (GB)

(72) Inventor: Daniel George PURKIS, Dyce (GB)

(73) Assignee: Well-Sense Technology Limited, Dyce, Aberdeen (GB)

(21) Appl. No.: 19/107,947

(22) PCT Filed: Sep. 29, 2023
(86) PCT No.: PCT/GB2023/052531

§ 371 Date: Feb. 28, 2025

(30) Foreign Application Priority Data
Sep. 30, 2022 (GB) 2214439.8

(51) Int. Cl. G01V 1/22; E21B 47/005; E21B 47/16; E21B 49/00; G01V 1/143; G01V 1/50

(52) U.S. Cl. CPC G01V 1/226; E21B 47/005; E21B 49/00; G01V 1/143; G01V 1/50; E21B 47/16

(57) ABSTRACT

A method of determining a property related to a wellbore having casing therein. The casing has tubing therein. The method comprises determining an optical response of a distributed sensing system deployed in tubing within casing of a wellbore to an acoustic wave travelling along at least a portion of the casing. The method further comprises determining a property related to the wellbore based on the optical response.

### TECHNICAL FIELD

The present disclosure relates generally to wellbores, and in particular to methods, systems and devices for determining a property of a wellbore.

### BACKGROUND

In a downhole environment, a borehole penetrating an earth formation includes a formation wall with casing disposed therein. An annular space (or annulus) positioned between the formation wall and the casing may be filled with a medium made of various materials, such as cement, drilling fluids, muds and/or other annulus solids. The medium may impose zonal isolation between different formations in order to avoid flow of fluids (e.g., water, gas, oil) from the formations through the annular space of the casing. Medium placement and integrity may also affect a well's architecture, for example, to ensure mechanical support of the casing and/or to provide protection from corrosion.

After the medium has set in the annular space, various destructive and non-destructive, e.g. acoustic testing, testing methods may be used to evaluate the integrity of the medium. Subsequent or prior to preforming these methods, tubing may be positioned within the casing thereby defining a second annular space (or annulus) positioned between the casing and the tubing.

Cement evaluation may be used to determine, for example, a location and/or presence of various materials that form the medium in the annular space. Various tools, such as those using acoustic waves, may be used to probe the medium outside the casing. Such evaluation may be used to detect potential problems that may arise, for example, when a bond between the medium and the casing has failed, when the medium has not fully set, when light weight and/or low density cements are used in the medium, and other real-world scenarios in which conditions are less than ideal, thus potentially leaving a range of annulus solids in the medium.

Further cement evaluation may be used in plug and abandonment (P&A) operations during decommissioning. Such operations may be based on previously collected cement bond logs (CBLs) or the bond between the cement and casing may be assessed after production. CBLs may have been obtained prior to casing insertion and production. Cement bonding may have deteriorated during production which may span several decades. P&A operations may require precise cement bond information in order to cut the casing/tubing prior to plugging the wellbore. Using such CBLs in P&A operations may result in sub-optimal wellbore plugging, and increase the potential for hazardous fluids to be released from the wellbore through poor cement bonds.

Further conventional ultrasonic imagers used to assess the bond between the casing and cement generally require removal of the tubing (production tubing) to have unimpeded access to the casing. Removing tubing is costly and time intensive as it may require securing the well and removing the tubing with an offshore rig, in some cases a mobile offshore drilling unit, in the case of an offshore well.

This background serves only to set a scene to allow a person skilled in the art to better appreciate the following description. Therefore, none of the above discussion should necessarily be taken as an acknowledgement that that discussion is part of the state of the art or is common general knowledge. One or more aspects/embodiments of the disclosure may or may not address one or more of the background issues.

### SUMMARY

According to an aspect of the disclosure there is provided a method of determining a property related to a wellbore. The method may provide a more accurate determination of the property than conventional methods. The method may be less computationally intensive in that fewer computational steps, resources and time may be required than conventional methods.

The wellbore may have downhole piping therein. In particular, the downhole pipe may comprise casing. The casing may have tubing therein. Accordingly, the wellbore may be at least partially defined by an outer casing, and an inner tubing.

The method may comprise determining an optical response of a distributed sensing system deployed in downhole piping, e.g., casing having tubing therein, to an acoustic wave travelling along at least a portion of the casing. In other words, an optical response of the piping may be determined via a distributed sensing system deployed in the piping. The optical response may comprise, or consist of a frequency response.

Along the downhole piping may comprise an acoustic wave travelling from an uphole position, e.g., at surface, to a downhole position of the downhole piping. The acoustic wave may thus travel down the downhole piping.

The acoustic wave may comprise a pressure wave, e.g., a longitudinal wave where vibration of a medium is parallel to the direction of wave travel, or a compression wave which produces compression and rarefaction when travelling through a medium, and/or a shear wave, e.g., a transverse wave where the displacement of medium is at right angles to wave propagation.

The optical response may comprise a frequency response. The frequency response may comprise spectral energy relative to depth in the wellbore over time. In other words, the frequency response may be the energy at a particular depth over time. Thus, the frequency response may provide an indication of energy at various times (or frequencies) and well depths. The frequency response may comprise spectral energy relative to depth in the wellbore over time. As the response is at a range of times and frequency is the inverse of time (or time is the inverse of frequency), the response is at a range of frequencies. For example, the energy may be determined through a frequency range of 4 to 2496 Hz at particular discrete frequency bands, e.g., 4-627 Hz, 627-1250 Hz, 1250-1873 Hz, 1873-2496 Hz. As such the frequency response may comprise frequency band energy (FBE). In another example, the energy may be determined through a frequency range below 100 to 200 Hz, e.g., 4 to 100 Hz and/or 4 to 200 Hz.

The spectral energy may be indicative or the vibration, e.g., oscillation, of the downhole piping within the wellbore. The level of vibration of the downhole piping, and accordingly the level of spectral energy, or characteristics of the spectral energy may be indicative of a property associated with the wellbore as will be described. Accordingly, determining the optical response, e.g., frequency response, may be used in determining a property associated with the wellbore based on detecting the vibration downhole of the downhole piping in the wellbore.

The acoustic wave in the piping may impart energy into the piping, e.g., mechanical energy. For example, the acoustic energy may cause a section of piping to vibrate within the wellbore. The optical response may highlight such vibration as energy in the wellbore at a particular frequency and depth. The energy may decay over time such that energy at a certain frequency and depth decreases over a time period.

The method may further comprise determining a property related to the wellbore based on the optical response. The optical response may comprise a frequency response. Determining the property may be based on a visual inspection of the frequency response. Additionally, or alternatively, the property may be determined by analysing the frequency for low or high spectral energy zones in the frequency response. For example, lower energy at a certain depth at a particular frequency may be indicative of a property of the wellbore such as a strong cement bond between the downhole piping and cement surrounding the piping. The determining may comprise processing the frequency response via one or more data analysis methods such as integrating the frequency response, and determining absolute or local maxima and/or minima.

Determining the optical response may comprise:
identifying a resonant frequency of the downhole piping; and
isolating a frequency response of the distributed sensing system at the resonant frequency.

The resonant frequency may comprise the frequency at which the downhole piping is in resonance. By identifying the resonant frequency of the wellbore and isolating this frequency in the frequency response, the highest spectral energy of the frequency response may be isolated for analysis. Thus, the computational requirements of the analysis may be reduced as a reduced data set is required for data analysis. This may improve operation of a processor and/or memory performing the data analysis.

Further by identifying a resonant frequency of particular downhole piping the same resonant frequency may be used on similar or other downhole piping thereby improving efficiency and reducing computational resources and time for performing the method on the other downhole piping.

Additionally, by isolating the frequency response at the resonant frequency greater resolution may be provided for determining a property of the wellbore based on the isolated frequency response. Such greater resolution allows for faster and/or more efficiency property determination. Additionally, the property may be more accurately determined using higher resolution data.

Identifying the resonant frequency may comprise identifying a time or frequency having a maximum strength. In this context strength may comprise an amplitude, instantaneous or average, of the frequency response at the frequency. The maximum strength may comprise the maximum spectral energy at a particular frequency of a range of frequencies. For example, if the frequency response is spectral energy relative to depth over time through a frequency range of 4 to 2496 Hz, the maximum strength may be at a frequency of 1500 Hz. The total, average, and/or instantaneous spectral energy at 1500 Hz may be higher than the spectral energy at other frequencies.

Identifying the resonant frequency may comprise identifying a dominant frequency in the frequency response. The dominant frequency may have the highest average, instantaneous, and/or total spectral energy in the frequency response.

Identifying the resonant frequency may comprise identifying one or more harmonics, i.e., harmonic frequencies, of the dominant frequency in the frequency response. The harmonic frequencies may have the highest average, instantaneous, and/or total spectral energy in the frequency response.

While a single frequency is mentioned, identifying the resonant frequency may comprise identifying a frequency range having a maximum strength. The frequency range may correspond with a particular frequency band having a maximum strength. In this context strength may comprise an amplitude, instantaneous or average, of the frequency response at the frequency. The maximum strength may comprise the maximum spectral energy at a particular frequency band of a range of frequencies. For example, the spectral energy may be determined through a frequency range of 4 to 2496 Hz at particular discrete frequency bands, e.g., 4-627 Hz, 627-1250 Hz, 1250-1873 Hz, 1873-2496 Hz. The maximum spectral energy may be present within the frequency band of 1250-1873 Hz. This frequency band may include the resonant frequency of the downhole piping. In another example, the frequency range may be below 100 to 200 Hz, e.g., 4 to 100 Hz and/or 4 to 200 Hz.

The optical response may comprise a frequency response. Determining the optical response may comprise determining the frequency response of the distributed sensing system in a frequency window including the resonant and/or harmonic frequencies. The frequency window may be predetermined based on properties of the downhole piping. For example, the downhole piping may be known to be similar to other downhole piping having a known resonant frequency. Thus, a particular frequency window may be selected containing the known resonant frequency. Determining the frequency response of the distributed sensing system in this frequency window may reduce computer processing requirements, both in terms of computing power and computing time, as less data will require processing. Accordingly, the method may be more efficient than known methods.

The optical response may comprise a frequency response. Determining the property may comprise processing the frequency response in the frequency domain. Processing the response in the frequency domain may comprise converting the response into the frequency domain. Converting the response into the frequency domain may comprise performing a fast Fourier transform (FFT) on the response. Operating in the frequency domain may allow for more efficient and accurate processing of the response in order to determine a property of the wellbore.

Determining the property may comprise processing the optical response by one or more data processing techniques such as stacking and the common midpoint method. In particular, the optical response may be collected at multiple start times resulting in a plurality of optical responses. The resulting plurality of optical responses may be added together, i.e., stacked, to reduce noise and improve overall data quality. In this stacking process, the start or input time of each acoustic wave travelling along the casing associated with the plurality of optical responses may be determined by the distributed sensing system deployed within the tubing.

The method may further comprise exciting at least a portion of the downhole piping to cause an acoustic wave to travel along the downhole piping. As previously described the acoustic wave may comprise a variety of waves, e.g., pressure, shear, longitudinal, and/or compression waves.

Exciting the downhole piping may comprise a variety of mechanisms such as hammering the downhole piping, applying acoustic energy to the piping via a speaker or piezo stack, or simply deploying the distributed sensing system in the downhole piping whereby the system itself causes an acoustic wave to travel along the piping, for example by contacting an inner surface of the piping during deployment.

The downhole piping may be excited by exciting a structure associated with the piping such as a wellhead or other structure associated with the piping. For example, acoustic energy may be applied to the wellhead of a wellbore such that an acoustic wave travels along the downhole piping.

Exciting may comprise applying acoustic energy to a wellhead associated with the wellbore. As described, the acoustic energy may be applied via a variety of mechanisms such as hammers, speakers, piezo stacks, etc.

Additionally, acoustic energy may be applied to the downhole piping or element associated with the downhole piping, e.g., wellhead, in a single action or multiple actions. For example, the wellhead of a wellbore may be hammered a single time to cause an acoustic wave to travel along the piping, or may be hammered multiple times to cause multiple acoustic waves to travel along the piping.

The method may further comprise exciting at least a portion of the casing to cause a plurality of acoustic waves to travel along the downhole piping, each acoustic wave of the plurality of acoustic waves having a different frequency. Determining the optical response may comprise determining a frequency response at each of the different frequencies of the plurality of acoustic waves. This may ensure at least one acoustic wave has a frequency of the resonant frequency of the downhole piping. Accordingly, the property may be determined using this resonant frequency to provide a greatest or maximum spectral energy which provides highest resolution data for the determination of the property. The property determination may accordingly be more accurate, efficiency and require fewer resources, e.g., computing time and processing requirements.

The method may further comprise exciting at least a portion of the downhole piping at a plurality of frequencies to generate the plurality of acoustic waves. Exciting the piping at the plurality of frequencies may comprise applying energy at a variety of frequencies via mechanical contact or electromagnetic signals into the piping, or associated components, e.g., the wellhead of a wellbore.

Determining the optical response of the distributed sensing system may comprise determining the optical response when the downhole piping is in resonance. Resonance may represent a highest spectral energy determined by the distributed sensing system deployed in the downhole piping. Resonance may comprise the frequency of the acoustic wave travelling along the downhole piping being approximately equal to the resonant frequency or natural frequency of the downhole piping. When the downhole piping is in resonance, the piping vibrates, e.g., oscillates, at higher amplitude or with greater spectral energy than when the downhole piping is not in resonance, e.g., at other frequencies. Determining the optical response of the distributed sensing system may comprise determining a frequency response when the casing and/or tubing is in resonance.

The method may further comprise exciting the downhole piping to determine a resonant frequency of the downhole piping.

The method may further comprise exciting the downhole piping at the resonant frequency to generate an acoustic wave along the downhole piping.

The property may comprise at least one of:
a location of a medium proximate the wellbore;
a property of a medium proximate the wellbore;
a property of a structure associated with the wellbore; and
a geological property of formation proximate the wellbore.

The medium may comprise concrete. The medium may comprise cement. The property may comprise assessing cement bond quality to the downhole piping. Cement bond quality may be an important factor in P&A operations as determining the strongest cement bond between cement surrounding the piping and the downhole piping before P&A operations may beneficially aid well integrity during a P&A operation.

The property of the structure may comprise properties of structure associated with the downhole piping. For example, the property comprise locations of downhole structures such as hangers, packers, cement shoes, downhole valves, etc.

The geological property may provide information of the formation surrounding the wellbore and downhole piping.

The method may further comprise comparing the optical response to other wellbore data. The optical response may be compared to previously-collected optical response(s) from the same or other wellbores. Such a comparison may provide assistance in determining the property.

The other wellbore data may comprise a cement bond log. The cement bond log may have been previously collected. The cement bond log may have been collected when the wellbore was a different lifecycle stage. For example, the method may be performed as part of P&A operations, while the cement bond log may have been collected prior to production after the wellbore had been drilled. As such the cement bond log may be out of date and may not represent a true representation of cement bond quality. However, comparing the optically response with the cement bond log may eliminate particular depths of the wellbore from analysis thereby reducing processing time and costs. Additionally, comparing the optical response with the cement bond log may improve the quality of the determination of the property by quality checking the determination against the cement bond log. This may accordingly improve a confidence level in the determined property.

The distributed sensing system may comprise a fibre optic line. The fibre optic line may be adapted to provide distributed temperature, pressure or acoustic sensing. As such the fibre optic line may form part of a distributed acoustic sensing (DAS) system. The fibre optic line may be connected to a processor and memory for collecting the optical response determined by the fibre optic line, and processing the optical response to determine the property. The fibre optic line may alternatively form part of distributed temperature sensing (DTS) or distributed pressure sensing (DPS) system.

The distributed sensing system may comprise the FiberLine Intervention (FLI) made by Well-Sense™.

The method may further comprise removing noise data. The optical response may comprise noise data. Removing the noise may improve the efficiency and accuracy of the property determination, and reduce processing time and computational requirements. The noise data may correspond to periods of inactivity. The periods of inactivity may correspond with periods during which an acoustic wave is not travelling along at least a portion of the downhole piping.

The method may further comprise normalising the optical response. Normalising the optical response may comprise removing portions of the optical response. The portions may correspond with fluid, e.g., liquid or gas, response to the acoustic wave travelling along the downhole piping. Fluid, in particular liquid, may produce high spectral energy in response to the acoustic wave. Such high energy may be removed to improve the ability to determine a property in the optical response. For example, determining cement bond quality to the downhole piping may be more efficiently and accurately determined without the high energy present which is caused by liquid responses to the acoustic wave.

The method may comprise collecting the optical response in the downhole piping via the distributed sensing system. The collected optical response may then be processed outside of the downhole piping. For example, the optical response may be processed at surface, e.g., mudline for offshore wellbores, or surface for onshore wellbores. The optical response may be transmitted to a remote location for processing where processing comprises determining the property. The remote location may be remote from the wellbore.

The downhole piping may comprise casing in the wellbore. The casing may comprise tubing therein. The distributed sensing system may be deployed within the tubing within the casing.

According to another aspect there is provided a method of assessing cement bond quality in a wellbore having casing therein, the casing having tubing therein. The method may provide a more efficient and/or accurate method of assessing cement bond quality than conventional methods. Additionally, or alternatively, the method may be computational more efficient, both in terms of computational time and processing resources.

The method may comprise determining an optical response of a distributed sensing system deployed in casing within tubing of a wellbore to an acoustic wave travelling along at least a portion of the casing. The optical response may comprise a frequency response.

In conventional system such optical response determination is not possible when tubing is present in casing. For example, an ultrasonic transducer may be deployed in casing and impart acoustic energy in the casing, the reflections or reverberations of which are detected at the transducer to determine properties of the casing or surrounding areas. However, such a determination may not be possible when the tubing is present within the casing. In P&A operations the determination may therefore require the removal of the tubing which is costly and time-consuming. Alternatively, the determination may be based on previously collected data, e.g., a cement bond log (CBL), which was collected prior to production and insertion of the tubing, and may therefore be inaccurate.

Accurately assessing cement bond quality to the casing may be required for determining where to plug the casing during P&A. Inaccurately assessing cement bond quality may lead to poor selection for the plug location leading to leaking or re-cutting of the casing. This may negatively impact the environment around the wellbore, and increase costs and time.

The method may further comprise assessing cement bond quality to the casing based on the optical response.

Usage of optical response in assessing cement bond quality allows for the tubing to still be present in the casing. The reduces time and costs for assessing cement bond quality. The cement bond quality may be used for selecting a plugging location of the casing in P&A operations. The cement bond quality is based on current information rather than historical information thereby improving the accuracy of the information reducing the risk of leaks or the need for re-plugging in P&A operations.

Along the downhole piping may comprise an acoustic wave travelling from an uphole position, e.g., at surface, to a downhole position of the downhole piping. The acoustic wave may thus travel down the downhole piping.

The acoustic wave may comprise a pressure wave, e.g., a longitudinal wave where vibration of a medium is parallel to the direction of wave travel, or a compression wave which produces compression and rarefaction when travelling through a medium, and/or a shear wave, e.g., a transverse wave where the displacement of medium is at right angles to wave propagation.

The optical response may comprise a frequency response. The frequency response may comprise spectral energy relative to depth in the wellbore over time. In other words, the frequency response may be the energy at a particular frequency at a particular depth over time. Thus, the frequency response may provide an indication of energy at various frequencies and well depths over time. The frequency response may comprise spectral energy relative to depth in the wellbore over time at a range of frequency bands. For example the energy may be determined through a frequency range of 4 to 2496 Hz at particular discrete frequency bands, e.g., 4-627 Hz, 627-1250 Hz, 1250-1873 Hz, 1873-2496 Hz. In another example, the energy may be determined through a frequency range below 100 to 200 Hz, e.g., 4 to 100 Hz and/or 4 to 200 Hz. As such the frequency response may comprise frequency band energy (FBE).

The spectral energy may be indicative or the vibration of the casing and/or tubing within the wellbore. The level of vibration of the casing and/or tubing, and accordingly the level of spectral energy, or characteristics of the spectral energy may be indicative of a cement bond quality.

The acoustic wave in the piping may impart energy into the casing and/or tubing, e.g., mechanical energy. For example, the acoustic energy may cause a section of casing and/or tubing to vibrate within the wellbore. The optical response, e.g., frequency response may highlight such vibration as energy in the wellbore at a particular frequency and depth. The energy may decay over time such that energy at a certain frequency and depth decreases over a time period.

Assessing the cement bond quality may comprise visually inspecting the optical response. The optical response may comprise a frequency response. Additionally, or alternatively to visually inspecting the frequency response, the cement bond quality may be assessed by analysing the frequency for low or high spectral energy zones in the frequency response. For example, lower energy at a certain depth at a particular frequency may be indicative of a strong cement bond between the casing and cement surrounding the casing. Analysing may comprise processing the frequency response via one or more data analysis methods such as integrating the frequency response, and determining absolute or local maxima and/or minima.

Determining the optical response may comprise:
identifying a resonant frequency of the casing and/or tubing; and
isolating a frequency response of the distributed sensing system at the resonant frequency.

The resonant frequency may comprise the frequency at which the casing and/or tubing is in resonance. By identifying the resonant frequency of the wellbore and isolating this frequency in the frequency response, the highest spectral energy of the frequency response may be isolated for analysis. Thus, the computational requirements of the analysis may be reduced as a reduced data set is required for data analysis. This may improve operation of a processor and/or memory performing the data analysis.

Further by identifying a resonant frequency of particular casing and/or tubing the same resonant frequency may be used on similar or other casing and/or tubing thereby improving efficiency and reducing computational resources and time for performing the method of the other casing and/or tubing.

Additionally, by isolating the frequency response at the resonant frequency greater resolution may be provided for determining a property of the wellbore based on the isolated frequency response. Such greater resolution allows for faster and/or more efficiency property determination. Additionally, the property may be more accurately determined using higher resolution data.

Identifying the resonant frequency may comprise identifying a frequency having a maximum strength. In this context strength may comprise an amplitude, instantaneous or average, of the frequency response at the frequency. The maximum strength may comprise the maximum spectral energy at a particular frequency of a range of frequencies. For example, if the frequency response is spectral energy relative to depth over time through a frequency range of 4 to 2496 Hz, the maximum strength may be at a frequency of 1500 Hz. The total, average, and/or instantaneous spectral energy at 1500 Hz may be higher than the spectral energy at other frequencies.

Identifying the resonant frequency may comprise identifying a dominant frequency in the frequency resonant. The dominant frequency may have the highest average, instantons, and/or total spectral energy in the frequency response.

Identifying the resonant frequency may comprise identifying one or more harmonics, i.e., harmonic frequencies, of the dominant frequency in the frequency response. The harmonic frequencies may have the highest average, instantaneous, and/or total spectral energy in the frequency response.

While a single frequency is mentioned, identifying the resonant frequency may comprise identifying a frequency range having a maximum strength. The frequency range may correspond with a particular frequency band having a maximum strength. In this context strength may comprise an amplitude, instantaneous or average, of the frequency response at the frequency. The maximum strength may comprise the maximum spectral energy at a particular frequency band of a range of frequencies. For example, the spectral energy may be determined through a frequency range of 4 to 2496 Hz at particular discrete frequency bands, e.g., 4-627 Hz, 627-1250 Hz, 1250-1873 Hz, 1873-2496 Hz. The maximum spectral energy may be present within the frequency band of 1250-1873 Hz. This frequency band may include the resonant frequency of the casing and/or tubing.

Determining the optical response may comprise determining a frequency response of the distributed sensing system in a frequency window including the resonant and/or harmonic frequencies. The frequency window may be predetermined based on properties of the casing and/or tubing. For example, the casing and/or tubing may be known to be similar to other casing and/or tubing having a known resonant frequency. Thus, a particular frequency window may be selected containing the known resonant frequency. Determining the frequency response of the distributed sensing system in this frequency window may reduce computer processing requirements, both in terms of computing power and computing time, as less data will require processing. Accordingly, the method may be more efficient than known methods.

Assessing the cement bond quality may comprise processing the optical response in the frequency or time domain.

Assessing the cement bond quality may comprise processing the optical response by one or more data processing techniques such as stacking and the common midpoint method. In particular, the optical response may be collected at multiple start times resulting in a plurality of optical responses. The resulting plurality of optical responses may be added together, i.e., stacked, to reduce noise and improve overall data quality. In this stacking process, the start or input time of each acoustic wave travelling along the casing associated with the plurality of optical responses may be determined by the distributed sensing system deployed within the tubing.

The method may further comprise exciting at least a portion of the casing to cause an acoustic wave to travel along the casing. As previously described the acoustic wave may comprise a variety of waves, e.g., pressure, shear, longitudinal, and/or compression waves.

Exciting the casing may comprise a variety of mechanisms such as hammering the casing, applying acoustic energy to the piping via a speaker or piezo stack, or simply deploying the distributed sensing system in the tubing within the casing whereby the system itself causes an acoustic wave to travel along the casing, for example by contacting an inner surface of the tubing during deployment.

The casing may be excited by exciting a structure associated with the casing such as a wellhead. For example, acoustic energy may be applied to the wellhead of a wellbore such that an acoustic wave travels along the casing.

Exciting may comprise applying acoustic energy to a wellhead associated with the wellbore. As described the acoustic energy may be applied via a variety of mechanisms such as hammers, speakers, piezo stacks, etc.

Additionally, acoustic energy may be applied to the casing or element associated with the downhole piping, e.g., wellhead, in a single action or multiple actions. For example, the wellhead of a wellbore may be hammered a single time to cause an acoustic wave to travel along the casing, or may be hammered multiple times to cause multiple acoustic waves to travel along the casing.

The method may further comprise exciting at least a portion of the casing to cause a plurality of acoustic waves to travel along the casing, each acoustic wave of the plurality of acoustic waves having a different frequency. Determining the optical response may comprise determining a frequency response at each of the different frequencies of the plurality of acoustic waves. This may ensure at least one acoustic wave has a frequency of the resonant frequency of the casing. Accordingly, the property may be determined using this resonant frequency to provide a greatest or maximum spectral energy which provides highest resolution data for the determination of the property. The property determination may accordingly be more accurate, efficiency and require fewer resources, e.g., computing time and processing requirements.

The method may further comprise exciting at least a portion of the casing at a plurality of frequencies to generate the plurality of acoustic waves. Exciting the casing at the plurality of frequencies may comprise applying energy at a variety of frequencies via mechanical contact or electromagnetic signals into the casing, or associated components, e.g., the wellhead of a wellbore.

Determining the optical response of the distributed sensing system may comprise determining the optical response when the casing and/or tubing is in resonance. Resonance may represent a highest spectral energy determined by the distributed sensing system deployed in the tubing within the casing. Resonance may comprise the frequency of the acoustic wave travelling along the casing and/or tubing being approximately equal to the resonant frequency or natural frequency of the casing and/or tubing. When the casing, for example, is in resonance, the casing vibrates, e.g., oscillates, at higher amplitude or with greater spectral energy than when the casing is not in resonance, e.g., at other frequencies. Determining the optical response of the distributed sensing system may comprise determining a frequency response when the casing and/or tubing is in resonance.

The method may further comprise exciting the casing to determine a resonant frequency of the casing.

The method may further comprise exciting the casing at the resonant frequency to generate an acoustic wave along the casing.

The method may further comprise exciting the casing at a harmonic of the resonant frequency to generate an acoustic wave along the casing.

The method may further comprise comparing the optical response to other wellbore data. The optical response may be compared to previously-collected optical response(s) from the same or other wellbores. Such a comparison may provide assistance in assessing cement bond quality.

The other wellbore data may comprise a cement bond log. The cement bond log may have been previously collected. The cement bond log may have been collected when the wellbore was a different lifecycle stage. For example, the method may be performed as part of P&A operations, while the cement bond log may have been collected prior to production after the wellbore had been drilled. As such the cement bond log may be out of date and may not represent a true representation of cement bond quality. However, comparing the optical response with the cement bond log may eliminate particular depths of the wellbore from analysis thereby reducing processing time and costs. Additionally, comparing the optical response with the cement bond log may improve a confidence level in the assessed cement bond quality.

The distributed sensing system may comprise a fibre optic line. The fibre optic line may be adapted to provide distributed temperature, pressure or acoustic sensing. As such the fibre optic line may form part of a distributed acoustic sensing (DAS) system. The fibre optic line may be connected to a processor and memory for collecting the optical response determined by the fibre optic line, and processing the optical response to determine the property. The fibre optic line may alternatively form part of distributed temperature sensing (DTS) or distributed pressure sensing (DPS) system.

The distributed sensing system may comprise the FiberLine Intervention (FLI) made by Well-Sense™.

The method may further comprise removing noise data. The optical response may comprise noise data. Removing the noise may improve the efficiency and accuracy of the cement bond quality assessment, and reduce processing time and computational requirements. The noise data may correspond to periods of inactivity. The periods of inactivity may correspond with periods during which an acoustic wave is not travelling along at least a portion of the casing.

The method may further comprise normalising the optical response. Normalising the optical response may comprise removing portions of the optical response. The portions may correspond with fluid, e.g., liquid or gas, response to the acoustic wave travelling along the casing. Fluid, in particular liquid, may produce high spectral energy in response to the acoustic wave. Such high energy may be removed to improve the ability to assess the cement bond quality. For example, determining cement bond quality to the downhole piping may be more efficiently and accurately determined without the high energy present which is caused by liquid responses to the acoustic wave.

The method may comprise collecting the optical response, e.g., frequency response, in the casing via the distributed sensing system. The collected optical response may then be processed outside of the downhole piping. For example, the optical response may be processed at surface, e.g., mudline for offshore wellbores, or surface for onshore wellbores. The optical response may be transmitted to a remote location for processing where processing comprises assessing cement bond quality. The remote location may be remote from the wellbore.

According to another aspect there is provided a non-transitory computer-readable medium having computer program code stored thereon. The code is executable on a processor for performing any of the described methods. The code may perform one or more steps of the methods.

According to another aspect there is provided a computer program product that when programmed into a suitable processor configures the processor to perform any of the methods disclosed herein. There may be provided a carrier medium, such as a physical or tangible and/or non-transient carrier medium, comprising the computer program product. The carrier medium may be a computer readable carrier medium.

According to another aspect there is provided a system for determining a property related to a wellbore having downhole piping therein. The downhole piping may comprise casing having tubing therein.

The system may comprise a processor and memory for determining an optical response, e.g., a frequency response, of a distributed sensing system deployed in downhole piping a wellbore to an acoustic wave travelling along at least a portion of the downhole piping, and for determining a property related to the wellbore based on the optical response.

The property may comprise an assessment of cement bond quality to the downhole piping.

The determining steps may comprise any of the features and elements described in respect of the described methods. Further the system may provide any of the benefits described in respect of the described methods.

The system may comprise distributed sensing system for deployment in downhole piping of a wellbore. The distributed sensing system may be for deployment in tubing within casing of the wellbore. The distributed sensing system may be as described with respect to the method. For example, the distributed sensing system may comprise FLI made by Well-Sense™.

The system may further comprise an acoustic wave generator for generating an acoustic wave along at least a portion of the downhole piping. The generator may comprise a variety of mechanisms for generating the acoustic wave such a hammer, a speaker, piezo stack, etc.

The acoustic wave generator may be adapted to generate a plurality of acoustic wave, each acoustic wave having a different frequency. The different frequencies may be used to determine the resonant and/or harmonic frequencies of the downhole piping and/or the maximum strength in the frequency response as previously-described.

The acoustic wave generator may be adapted to generate a chirp or sweep signal where the acoustic wave increases or decreases through a range of frequencies.

The processor and memory may be located remote to the wellbore. The processor and memory may be located at surface or mudline of the wellbore.

According to another aspect there is provided an acoustic wave generator for generating an acoustic wave along at least a portion of downhole piping within a wellbore, the acoustic wave detectable by a distributed sensing system deployed in the downhole piping as an optical response, e.g., frequency response, to determine a property related to the wellbore.

As described the downhole piping may comprise casing having tubing therein.

The property may be cement bond quality of cement surrounding the downhole piping. The acoustic wave generator may comprise at least one of:
a device for striking at least a portion of the downhole piping, wellbore, wellhead, or surrounding ground or sea bed associated with the wellbore;
a transducer;
a speaker; and
a piezoelectric device.

The acoustic wave generator may comprise any of the features and elements described in respect of the described methods, and system. Further the generator may provide any of the benefits described in respect of the described methods and systems. According to another aspect there is provided use of a distributed sensing system in which a downhole pipe is acoustically excited and a property of the downhole pipe is determined based on an optical response, e.g., frequency response, of the distributed sensing system with the downhole pipe.

The use may comprise any of the features and elements described in respect of the described methods, system and generator. Further the generator may provide any of the benefits described in respect of the described methods, system and generator.

The invention includes one or more corresponding aspects, embodiments or features in isolation or in various combinations whether or not specifically stated (including claimed) in that combination or in isolation. As will be appreciated, features associated with particular recited embodiments relating to systems may be equally appropriate as features of embodiments relating specifically to methods of operation or use, and vice versa.

It will be appreciated that one or more embodiments/aspects may be effective in providing downhole communication, and in particular acoustic communications (e.g. for the purpose of telemetry methods and systems control).

The above summary is intended to be merely exemplary and non-limiting.

### BRIEF DESCRIPTION OF THE DRAWINGS

These and other aspects of the present disclosure will now be described, by way of example only, with reference to the accompanying Figures, in which:

FIG. 1 is a diagrammatic illustration of a system for determining a property related to a wellbore;

FIG. 2 is a part sectional view of a device of the system of FIG. 1, shown in side elevation;

FIG. 3 is a part sectional view of a wellhead of the system of FIG. 1, shown in side elevation;

FIG. 4 is a flowchart of a method of determining a property related to a wellbore;

FIG. 5 is a graph of spectral energy at a depths relative to time;

FIG. 6a is a graph of spectral energy at a dominant frequency of the casing over time;

FIG. 6b is a graph of the amplitude of the graph of FIG. 6a; and

FIG. 7 is a series of graphs of a fast Fourier transform (FFT) of spectral energy at a variety of depths.

### DETAILED DESCRIPTION OF THE DRAWINGS

The foregoing summary, as well as the following detailed description of certain embodiments will be better understood when read in conjunction with the accompanying drawings. As will be appreciated, like reference characters are used to refer to like elements throughout the description and drawings. As used herein, an element or feature recited in the singular and preceded by the word “a” or “an” should be understood as not necessarily excluding a plural of the elements or features. Further, references to “one example” or “one embodiment” are not intended to be interpreted as excluding the existence of additional examples or embodiments that also incorporate the recited elements or features of that one example or one embodiment. Moreover, unless explicitly stated to the contrary, examples or embodiments “comprising”, “having” or “including” an element or feature or a plurality of elements or features having a particular property might further include additional elements or features not having that particular property. Also, it will be appreciated that the terms “comprises”, “has” and “includes” mean “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of describing the relationship of an element or feature to another element or feature as depicted in the figures. The spatially relative terms can however, encompass different orientations in use or operation in addition to the orientation depicted in the figures.

Reference herein to “example” means that one or more feature, structure, element, component, characteristic and/or operational step described in connection with the example is included in at least one embodiment and or implementation of the subject matter according to the present disclosure. Thus, the phrases “an example,” “another example,” and similar language throughout the present disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the element or feature to the physical characteristics of the element or feature preceding the phrase “configured to”.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within less than 10% of, within less than 5% of, within less than 1% of, within less than 0.1% of, or within less than 0.01% of the stated amount.

Aspects of the present disclosure relate to a method and associated systems and devices of determining a property, such as a cement bond, related to a wellbore having downhole piping therein. Exemplary downhole piping may comprise casing having tubing therein. The method comprising an optical response of a distributed sensing system deployed in tubing within casing, of a wellbore to an acoustic wave travelling along the casing. The acoustic wave generated in the casing causes the casing to vibrate, e.g., oscillate, in some manner. Alternatively, or additionally, other elements related to the casing may vibrate. The distributed sensing system detects the effects of the acoustic wave through the casing in an optical response.

The optical frequency may be the frequency response. By operating in the frequency domain the distributed sensing system may be deployed in tubing within casing within the wellbore. The tubing may be maintained within the casing, i.e., the tubing does not need to be removed, to determine a property related to the wellbore such as assessing the cement bonding between the casing and surrounding cement.

In conventional methods of assessing cement bonding such an assessment is not possible thru-tubing, i.e., with the tubing still present within the casing. Instead, in conventional methods the tubing must first be removed in order to assess the cement bond between the casing and surrounding cement. This is costly and time intensive thereby negatively impacting P&A operations where the location of strongest or best cement bond is relevant information in order to cut the casing/tubing after plugging the wellbore.

Determining the optical, e.g., frequency response, allows the effects of vibration, e.g., oscillation, of the tubing within the casing to be determined and/or isolated while still being able to determine the vibration of the casing. In other words, the vibration of the casing is determinable from the frequency response despite vibration of the tubing. A property of the wellbore, such as an assessment of cement bonding between the casing and surrounding cement may then be determined from the frequency response. This may involve a visual inspection of the frequency response which is a representation of spectral energy at increasing depths over time at a range of frequencies. The visual inspection may represent a correlation of areas of high spectral energy with areas of a strong cement bond, e.g., “good” cement, or areas of low spectral energy with areas of a strong cement bond, e.g., “good” cement. “Bad” cement may be detectable as a weak cement bond between the casing and surrounding cement may result in increased vibration of the casing viewable as increased spectral energy at a particular depth over time. The spectral energy may decay over time.

As will be described various methods of generating the acoustic wave in the wellbore are possible. Additionally, various methods of improving the resolution of the optical response, e.g., frequency response, are possible to improve the efficiency and accuracy of the assessing the cement bond.

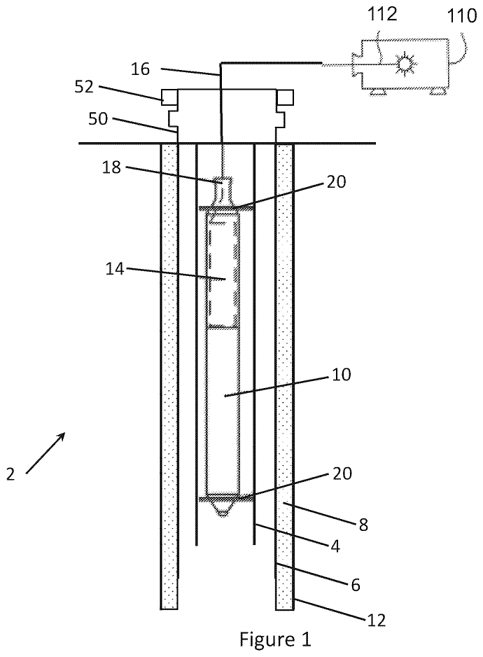

FIG. 1 is a diagrammatic illustration of a system 2 for determining a property related to a wellbore 12. The system 2 comprises a device 10 deployed within a wellbore 12.

Specifically, the device 10 is deployed within tubing 4, e.g., production tubing, within casing 6, i.e., casing string, within the wellbore 12. Surrounding the casing 6 is a medium. In the illustrated embodiment the medium comprises cement 8. The cement 8 is positioned between the casing 6 and the formation into which the wellbore 12 is formed, e.g., drilling, during the drilling phase of the associated well.

The wellbore 12 is accessible via an associated wellhead 50. The wellhead 50 may provide structural support for the tubing 4 within the casing 6. The wellhead 50 may include pressure control equipment such as a blowout prevent (BOP) and one or more valves, controllers, etc.

The device 10 includes a spool 14 of optical fibre 16, such that as the device 10 traverses the wellbore 12 the fibre 16 is deployed from an exit 18 at the trailing end of the device 10. The fibre 16 may be used during or after deployment for multiple applications, such as for communication. In some examples the fibre 16 may be used for distributed sensing within the wellbore 12, such as distributed temperature sensing (DTS), distributed pressure sensing (DPS), distributed acoustic sensing (DAS), and/or the like. Thus, the optical fibre 16 is a distributed sensing system.

The system 2 further comprises a surface device 110. The device 10 is connected via the optical fibre 16 to the surface device 110. In particular, the fibre 16 is connected at a first end 112 to the surface device 110.

The surface device 110 comprises a light source. The light source may be a laser source. The surface device 110 may be configured for use as an optical time-domain reflectometer (OTDR) for use in measuring the total length of the optical fibre 16 by looking for light reflection from the deployed optical fibre 16. The range finder analyses back scatter along the length of the optical fibre 16.

The surface device 110 may further comprise an interrogator. In this way, the optical fibre 16 may be used for the purposes of distributed sensing, such as DTS, DPS and/or DAS. The surface interrogator is of the type used with fibre optic systems. The light source generates a light or laser pulse at a desired frequency through the optical fibre 16 which may then be backscattered to the surface interrogator. The surface interrogator then determines the optical signature of the optical fibre 16.

The system 2 further comprises an acoustic wave generator 52 affixed to the wellhead 50. The generator 52 generates an acoustic wave which travels along the casing 6. The acoustic wave generated by the acoustic wave generator 52 is detectable by the optical fibre 16.

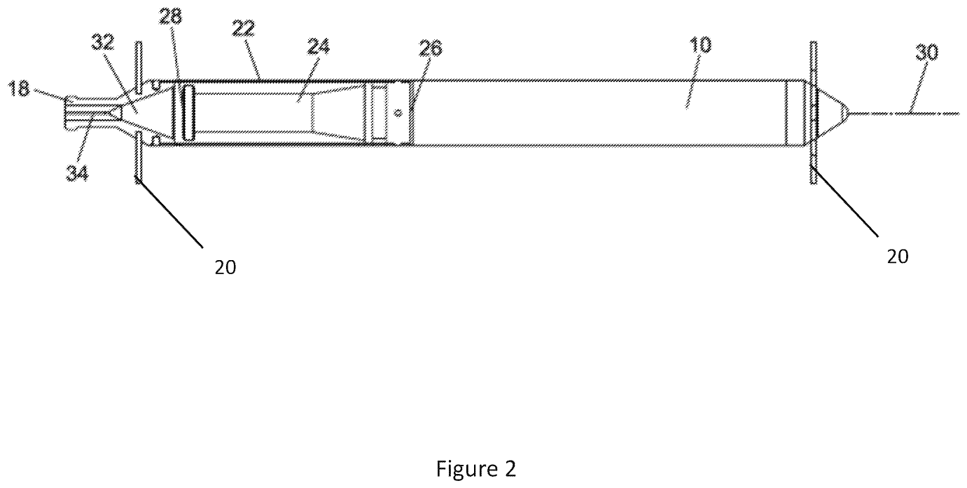

The device 10 is shown in more detail in FIG. 2. The device 10 is generally cylindrical in form, and in the illustrated arrangement includes centralising elements 20 at opposing ends thereof for facilitating centralisation of the device 10 in the wellbore 12 as shown in FIG. 1.

As illustrated in FIG. 2, the device 10 comprises a cavity region 22 shown in cross-section, wherein the cavity region 22 accommodates the spool of optical fibre. A bobbin 24 of the spool is illustrated with no fibre wound thereon for clarity purposes. The bobbin 24 is mounted within the cavity 22 in cantilever form such that the bobbin 24 defines a fixed or proximal end 26 and a free or distal end 28, and arranged to be coaxial with the axis 30 of the device 10.

The device 10 includes an internal funnel 32 which functions to guide fibre despooled from the bobbin 24 towards the exit 18. The exit 18 includes a throughbore 34 which is dimensioned to a similar diameter as the fibre, and in some examples the bore 34 may provide a degree of resistance to fibre passing therethrough. This may assist to control the rate and/or tension of fibre deployment. In some examples a volume of grease or similar material may be provided within the cavity 22, for example within the internal funnel 32. Such grease may become coated on a fibre during deployment from the device 10. The grease may function to provide a degree of resistance to the deployment of the fibre, to permit the fibre to stick to a wall of the wellbore 12, to protect the fibre, to provide lubrication to the fibre and the like. The optical fibre 16 is wound on the bobbin 24.

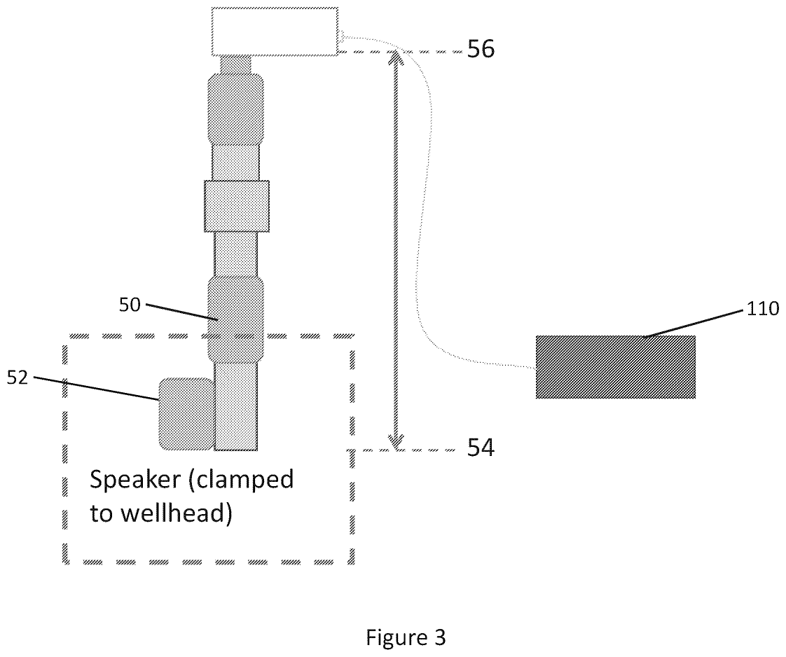

The acoustic wave generator 52 affixed to the wellbore 50 is illustrated in more detail in FIG. 3. The optical fibre 16 deployed from the device 10 passes through a tubing head flange 54 of the wellhead 50 to a connector 56 through which the optical fibre 16 is connected to the surface device 110. The optical fibre 16 from the connector 56 to the surface device 110 may be located at surface. This surface connection may be protected from the environment by a protective wrap or sheath. The frequency response detected by the optical fibre 16 is processed at the surface device 110 as will be described.

In particular, the surface device 110 comprises a processor and memory for determining a frequency response of the optical fibre 16 deployed in the tubing 4 in the casing 6 to an acoustic wave generated by the acoustic wave generator 52. The processor and memory may process the frequency response to determine a property related to the wellbore 12, e.g., cement bond assessment of the cement bond to the casing 6.

The acoustic wave generator 52 is affixed to the wellhead 50 to generate an acoustic wave along the casing 6. In the illustrated arrangement the acoustic wave generator 52 is clamped to the wellhead 50. Further, in the illustrated arrangement the acoustic wave generator 52 comprises a speaker which generates acoustic waves at a variety of frequencies, i.e., through a frequency range, e.g., 4 to 2496 Hz.

As one skilled in the art will appreciate other connection means, and other acoustic wave generators may be used. For example, the acoustic wave generator 52 may comprise a hammer which is operated by hand, or by some other means (e.g., a solenoid), to strike the wellhead 50 with a particular force to generate an acoustic wave along the casing 6. The size of the hammer may be changed to vary the frequency, and/or the striking force, i.e., the force applied to the wellhead 50 by the hammer, may be changed to vary the frequency of the acoustic wave. Further the acoustic wave generator 52 may comprise one or more speakers each configured to generate an acoustic signal having a different frequency. Alternatively, the acoustic wave generator 52 may comprise one or more speakers configured to generate a plurality of acoustic signals, each having a different frequency.

The acoustic wave generator 52 may generate a chirp or sweep signal where the acoustic wave generated in the casing 6 increases or decreases through a range of frequencies. The acoustic wave generator 52 may generate an acoustic wave having a frequency of the resonant frequency of the casing 6, or some harmonic of the resonant frequency of the resonant frequency of the casing 6.

The acoustic wave generator 52 is affixed to the wellhead 50 at a lubricator of the wellhead 50. In particular, the acoustic wave generator 52 is strapped to the lubricator such that the wave generator 52 causes an acoustic wave to travel through the lubricator and along the casing 6.

Generally, the acoustic wave generator 52 causes an acoustic wave to travel along the casing 6 downhole of the wellhead 50. The acoustic wave imparts energy into the casing 6 such that the casing 6 vibrates, e.g., oscillates, within the wellbore 12. Vibration of the casing 6 (and potentially tubing 4 or other components associated with the wellbore 12) is detected by the optical fibre 16 within the wellbore 12. The vibration detected by the optical fibre 16 of the device 10 is processed at the surface device 110 to determine the frequency response.

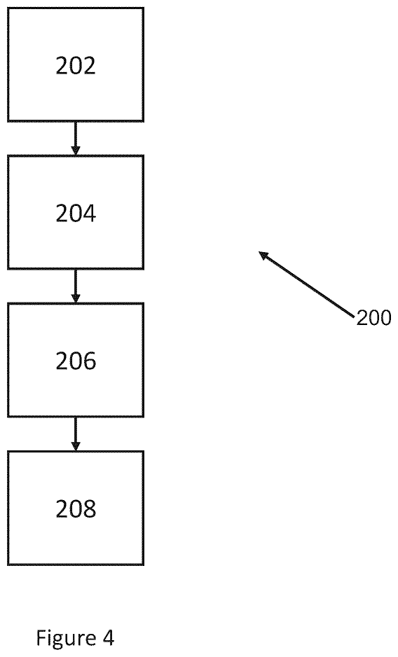

This operation of the system 2 is depicted in the flowchart of FIG. 4. FIG. 4 illustrates a method 200 for determining a property related to a wellbore. In the illustrated method, the property is a cement bond assessment of the cement 8 to the casing 6. The method 200 comprises determining 202 an optical response, e.g., frequency response, to an acoustic wave travelling along at least a portion of the casing 6. The acoustic wave is generated by the acoustic wave generator 52 and travels along the casing 6 downhole from the wellhead 50. The casing 6 may vibrate within the wellbore 12 such that spectral energy is detected by the device 10, i.e., the optical fibre 16, deployed in the tubing 4 within the casing 10. The response is determined with the optical fibre 16 forming part of a DAS system which further utilizes the surface device 110 as described.

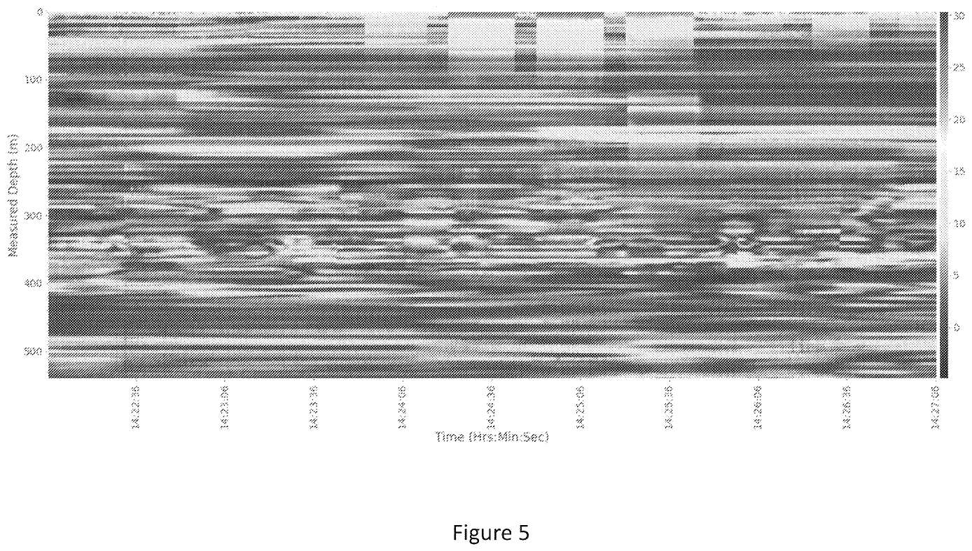

The spectral energy at various depths of the wellbore at various times is illustrated in FIG. 5. The gradient in the spectral energy indicates the spectral energy at a particular depth and a particular time. For example, the spectral energy at 14:23:06 at a depth of approximately 200 metres is greater than the spectral energy at 14:23:36 at a depth of approximately 450 metres. The spectral energy may indicate a level of vibration or a lack of vibration of the casing 6 within the wellbore 12.

As shown in FIG. 5, the spectral energy may be higher at a certain time (frequency). For example, the spectral energy at 14:25:06 may have a higher overall value than at other times. This higher strength signal may correspond with the resonant frequency of the casing 6, or a harmonic thereof. Thus, the method 200 further comprises identifying 204 a resonant frequency of the casing 6. In other words, the highest overall total spectral energy at a particular time is identified as the resonant frequency (time) of the casing 6. This portion of the response is then isolated 206 from the rest of the response.

Identifying 204 the resonant frequency of the casing 6 may comprise performing a fast Fourier transform (FFT) on the frequency response to process the response in the frequency domain.

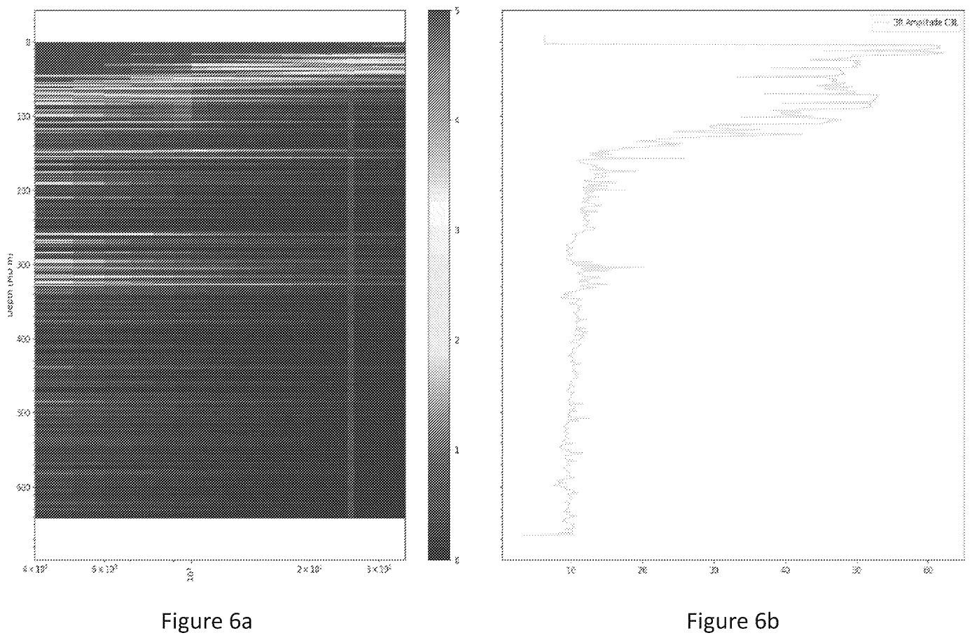

The isolated response is illustrated in FIG. 6a. The peak spectral energy, i.e., the amplitude of the spectral energy, at depth is shown in isolation in FIG. 6b. As visible in FIGS. 6a and 6b the spectral energy exhibits various peaks, i.e., high amplitudes, indicating higher energy at certain depths. The location of these peaks may be used to determine a property of the wellbore 12.

Thus, the method 200 further comprises determining 208 a property of the wellbore based on the response. In the illustrated arrangement the isolated response is compared to previously-collected CBLs of the wellbore 12 prior to insertion of the casing 6 and production. Depths of low amplitude (low spectral energy) indicate good cement, i.e., a strong bond between casing 6 and surrounding cement 8. Depths of high amplitude (high spectral energy) indicate bad cement, i.e., a weak bond between casing 6 and surrounding 8. Depths having low amplitude generally correlate with similar depths determined by the CBLs verifying the results of the method 200.

The depths having “good cement” may then be in planning P&A operations with the certainty that the bond between casing 6 and cement 8 is strong such that leaks are unlikely. Further the tubing 4 need not be removed to assess the cement bond quality reducing the costs and time involved.

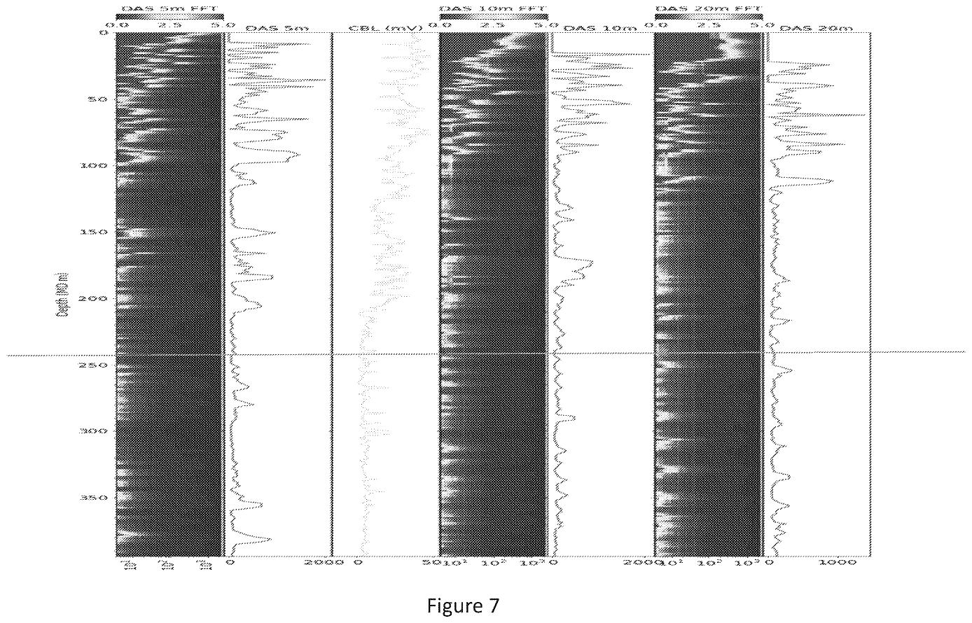

Isolated responses at various gauge lengths (GL=5 m, GL=10 m and GL=20 m) are illustrated in FIG. 7 along with extrapolated amplitudes of the isolated responses. These are presented alongside the CBL of the wellbore 12 which was collected prior to tubing 4 insertion and production. Low spectral energy, i.e., low amplitudes, for example at a depth of 245 m is shown to correlated with a CBL having a lower signal peak. This depth may represent “good cement” and be useful in planning P&A operations.

It should be understood that the examples provided are merely exemplary of the present disclosure, and that various modifications may be made thereto.

1. A method of determining a property related to a wellbore having casing therein, the casing having tubing therein, the method comprising:
determining an optical response of a distributed sensing system deployed in tubing within casing of a wellbore to an acoustic wave travelling along at least a portion of the casing; and
determining a property related to the wellbore based on the optical response.

2. The method of claim 1, wherein the optical response comprises spectral energy relative to depth in the wellbore over time.

3. The method of claim 1, wherein determining the optical response comprises:
identifying a resonant frequency of the casing; and
isolating a frequency response of the distributed sensing system at the resonant frequency.

4. The method of claim 3, wherein identifying the resonant frequency comprises identifying a signal having a maximum strength.

5. The method of claim 3, wherein determining the optical response comprises determining a frequency response of the distributed sensing system in a frequency window including the resonant frequency, wherein determining the property comprises processing the optical response in the frequency domain.

6. (canceled)

7. The method of claim 1, further comprising exciting at least a portion of the casing to cause an acoustic wave to travel along the casing. wherein exciting comprises applying acoustic energy to a wellhead associated with the wellbore.

8. (canceled)

9. The method of claim 1, further comprising exciting at least a portion of the casing to cause a plurality of acoustic waves to travel along the casing, each acoustic wave of the plurality of acoustic waves having a different frequency.

10. The method of claim 9, further comprising exciting at least a portion of the casing at a plurality of frequencies to generate the plurality of acoustic waves.

11. The method of claim 1, wherein determining the optical response of the distributed sensing system comprises determining the optical response when the casing is in resonance.

12. The method of claim 11, further comprising exciting the casing to determine a resonant frequency of the casing.

13. The method of claim 12, further comprising exciting the casing at the resonant frequency to generate an acoustic wave along the casing.

14. The method of claim 1, wherein the property comprises at least one of:
a location of a medium proximate the wellbore;
a property of a medium proximate the wellbore;
a property of a structure associated with the wellbore; and
a geological property of formation proximate the wellbore.

15. (canceled)

16. The method of claim 1, further comprising:
comparing the optical response to other wellbore data, wherein determining the property comprises determining the property based on a comparison of the optical response to other wellbore data.

17. (canceled)

18. The method of claim 16, wherein other wellbore data comprises a cement bond log.

19. (canceled)

20. A non-transitory computer-readable medium having computer program code stored thereon, the code executable on a processor for performing the method of claim 1.

21. A system for determining a property related to a wellbore having casing therein, the casing having tubing therein, the system comprising:
a processor and memory for determining an optical response of a distributed sensing system deployed in tubing within casing of a wellbore to an acoustic wave travelling along at least a portion of the casing, and for determining a property related to the wellbore based on the optical response.

22. The system of claim 21, further comprising at least one of a distributed sensing system for deployment in tubing within casing of a wellbore, and an acoustic wave generator for generating an acoustic wave along at least a portion of the casing.

23. (canceled)

24. The system of claim 22, wherein the acoustic wave generator is adapted to generate a plurality of acoustic waves, each acoustic wave having a different frequency.

25. (canceled)

26. An acoustic wave generator for generating an acoustic wave along at least a portion of casing within a wellbore, the casing having tubing therein, the acoustic wave detectable by a distributed sensing system deployed in the tubing as an optical response to determine a property related to the wellbore.

27. The acoustic wave generator of claim 26, wherein the acoustic wave generator comprises at least one of:
a device for striking at least a portion of the casing, wellbore, tubing, wellhead, or surrounding ground or sea bed associated with the wellbore;
a transducer;
a speaker; and
a piezoelectric device.

28. (canceled)
